(19) United States
(12) Patent Application Publication
(10) Pub. No.: US 2025/0231091 A1
(43) Pub. Date: Jul. 17, 2025

(54) LIGHT HYDROCARBON SAMPLING SYSTEM AND METHODS OF USE THEREOF

(71) Applicant: Hydrocarbon Analytics LLC, Austin, TX (US)

(72) Inventors: Curtis Christopher Gulaga, Austin, TX (US); Paul Anthony Mullen, Austin, TX (US); Henry Alan James, Austin, TX (US)

(73) Assignee: Hydrocarbon Analytics LLC, Austin, TX (US)

(21) Appl. No.: 18/410,458

(22) Filed: Jan. 11, 2024

(51) Int. Cl. G01N 1/20; G01N 1/14; G08B 21/18

(52) U.S. Cl. CPC G01N 1/2035; G01N 1/14; G01N 2001/205; G08B 21/187

(57) ABSTRACT

A sampling system is provided for sampling fluids flowing through a pipe. The system includes at least two accumulator vessels; a single sampling pump for collection of samples and delivering samples via sampling lines to one or more of the at least two accumulators; one or more product valves associated with each of the accumulator vessels actuatable to direct sample flow to a particular accumulator vessel depending on the status of each of the at least two accumulator vessels; and a control system in connection with the sampling pump, product valves and accumulator vessels for automation of the pumping of samples to a particular accumulator vessel, depending on status of each of the at least two accumulator vessels, to ensure consistent sample taking and accumulation. The control system and sample pump is configured to accommodate bi-directional flow of fluid travelling through the pipe.

### FIELD OF THE INVENTION

The present disclosure provides a sampling system for light hydrocarbons and methods of using the same.

### INTRODUCTION

Light liquid hydrocarbon sampling systems are designed to sample light liquid hydrocarbons including propane, butane, condensates, and other refined liquid products from pipelines as well as from truck off loading, upstream and midstream facilities. The purpose of light liquid hydrocarbon sampling systems is to capture a representative liquid sample of the pipeline product. Individual product samples are analyzed to determine liquid composition make up of various commodities including C1, C2, C3, C4, C5, C6 & C7. Data from the multiple individual samples can be combined to develop a representative, composite sample of the flowing pipeline.

With reference to FIG. 1, sampling systems typically include primary components such as a sample pump, an accumulator vessel, a pre-charge gas vessel, and a control system, all arranged on a skid system and placed at the pipeline or facility being sampled. The skid unit should have a size and weight for ease of transport to remote locations and for ease of moving from place to place as an option or for removal for maintenance or repair purposes. The sample pumps are connected to probes inserted into the flowing liquid of the pipeline, or facility.

In typical sampling system operation, when the system receives a signal that the pipeline is flowing at full or normal capacity, the control unit energizes either a solenoid valve, or other means actuates the sample pump to pump a small sample into the product accumulator vessel. Once the solenoid valve, or other means are de-energized, the sample pump is readied for capturing a new sample. The sampled product is maintained in a liquid phase within the accumulator vessel by means of pressure applied to the sampled product within the product accumulator vessel. In some cases, pressure can be applied by a piston in the vessel that is actuated by pressurized gas from the pre-charge gas system.

The sample vessel fills to a desired capacity by the end of a given sample period. Once the sample period is complete, the product within the vessel is mixed and a representative sample is removed for testing. Following taking of the representative sample, a remainder of the light liquid product is drained from the accumulator vessel. The process begins again with a new sample period, mixing, and taking of a next representative sample for testing. During draining, product continues to flow through the pipeline or facility, which can be missed from sampling due to down time.

### SUMMARY

A sampling system is provided for sampling fluids flowing through a pipe. The system includes at least two accumulator vessels; a single sampling pump for collection of samples and delivering samples via sampling lines to one or more of the at least two accumulators; one or more product valves associated with each of the accumulator vessels actuatable to direct sample flow to a particular accumulator vessel depending on the status of each of the at least two accumulator vessels; and a control system in connection with the sampling pump, product valves and accumulator vessels for automation of the pumping of samples to a particular accumulator vessel, depending on status of each of the at least two accumulator vessels, to ensure consistent sample taking and accumulation. The control system and sample pump is configured to accommodate bi-directional flow of fluid travelling through the pipe.

It is to be understood that other aspects of the present disclosure will become readily apparent to those skilled in the art from the following detailed description, wherein various embodiments of the disclosure are shown and described by way of illustration. As will be realized, the disclosure is capable of other and different embodiments and its several details are capable of modification in various other respects, all without departing from the spirit and scope of the present disclosure. Accordingly, the drawings and detailed description are to be regarded as illustrative in nature and not as restrictive.

### BRIEF DESCRIPTION OF THE DRAWINGS

A further, detailed, description of the disclosure, briefly described above, will follow by reference to the following drawings of specific embodiments of the disclosure. The drawings depict only typical embodiments of the disclosure and are therefore not to be considered limiting of its scope. In the drawings:

FIG. 1 is a schematic diagram of a prior art light liquid hydrocarbons sampling system;

FIG. 2A is a first perspective view of a 2-accumulator hydrocarbon sampling system of the present disclosure;

FIG. 2B is a second perspective view of the hydrocarbon sampling system of FIG. 2A;

FIG. 2C is a cross sectional elevation view one embodiment of an accumulator of the hydrocarbons sampling system of FIG. 2A;

FIG. 2D is a side elevation view of the hydrocarbons sampling system of FIG. 2A;

FIG. 2E is a top plan view of the hydrocarbons sampling system of FIG. 2A;

FIG. 3 is a perspective view of an embodiment of a system of the present disclosure, showing piping connections of the product lines, pressurized gas lines and instrumentation lines;

FIG. 4 is a perspective view of an embodiment of a system of the present disclosure, together with a schematic diagram of one example of a control system and communications module of the present system;

FIG. 5A is a first perspective view of a 4-accumulator hydrocarbon sampling system of the present disclosure;

FIG. 5B is a front elevation view of the hydrocarbon sampling system of FIG. 5A;

FIG. 5C is a side elevation view of the hydrocarbons sampling system of FIG. 5A;

FIG. 5D is a back elevation view of the hydrocarbons sampling system of FIG. 5A; and

FIG. 5E is a top plan view of the hydrocarbons sampling system of FIG. 5A.

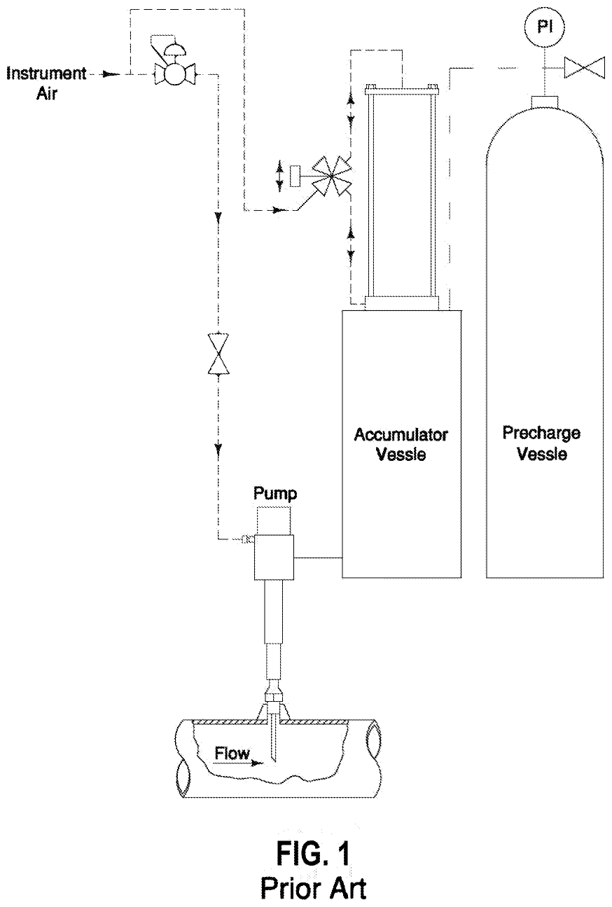

The drawings are not necessarily to scale and in some instances proportions may have been exaggerated in order to more clearly depict certain features.

### DETAILED DESCRIPTION

The description that follows and the embodiments described therein are provided by way of illustration of an example, or examples, of particular embodiments of the principles of various aspects of the present disclosure. These examples are provided for the purposes of explanation, and not of limitation, of those principles and of the disclosure in its various aspects.

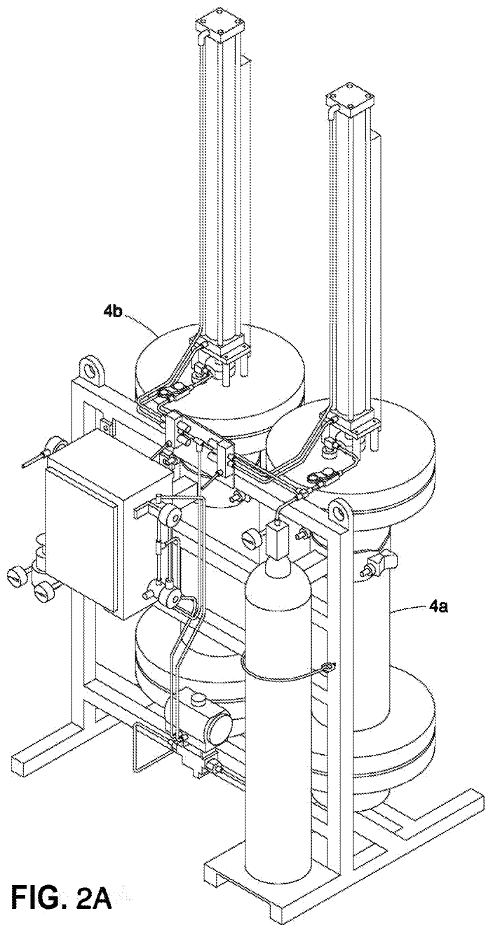

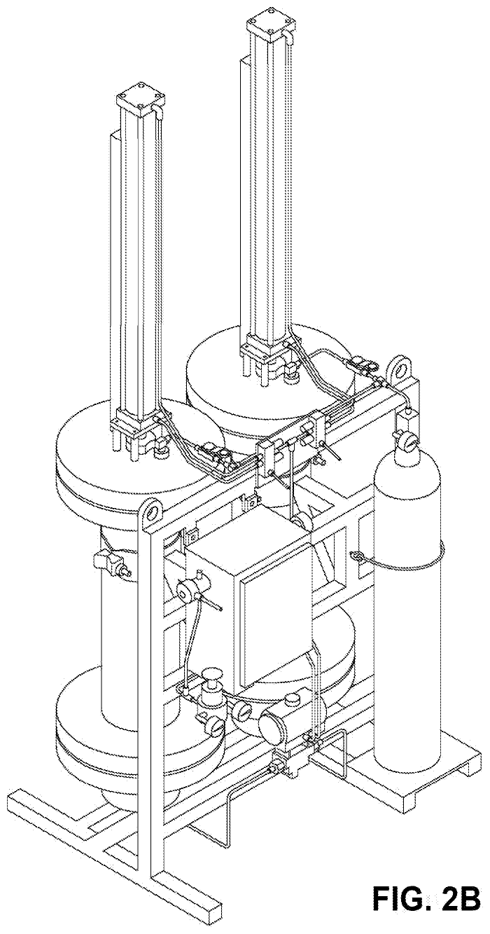

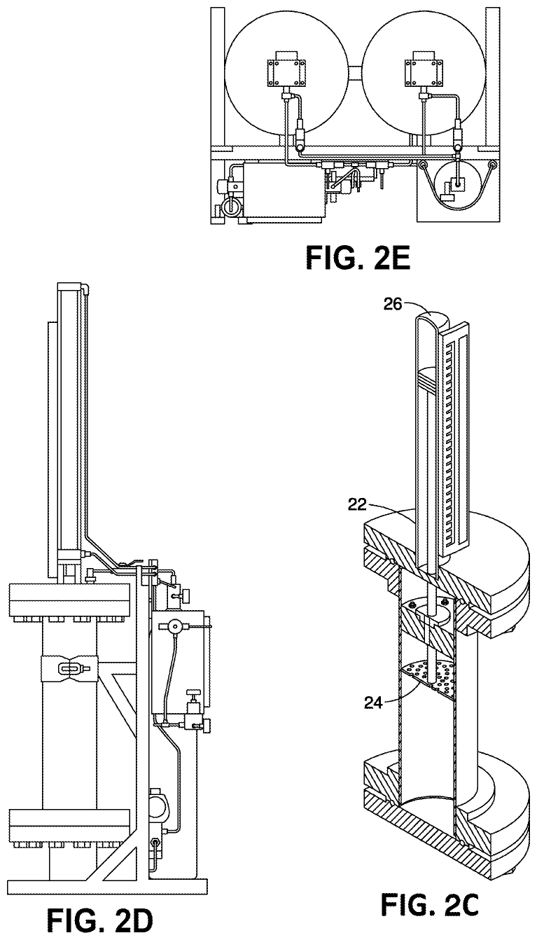

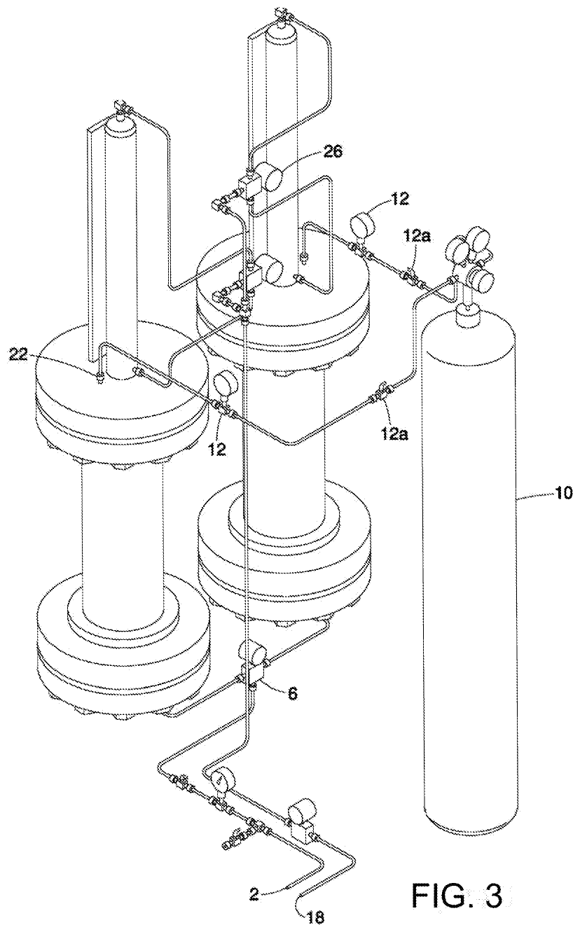

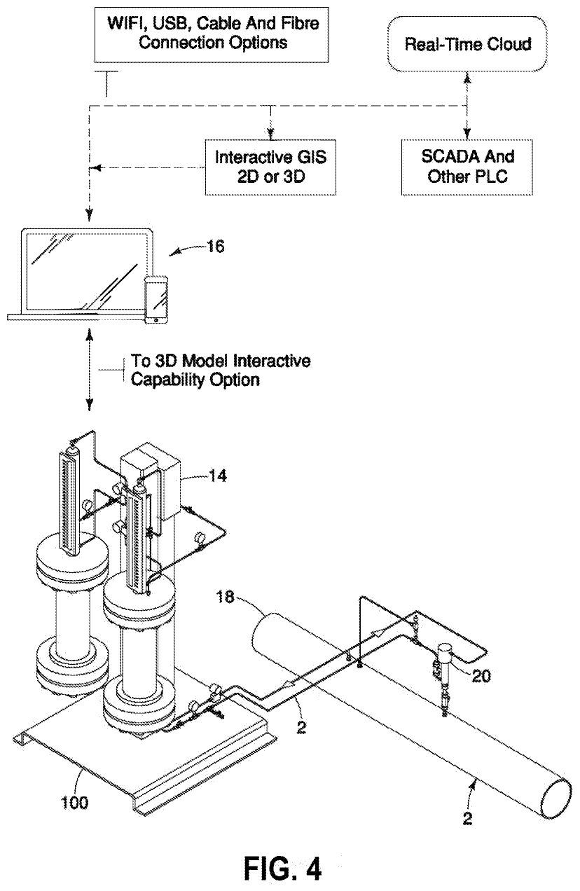

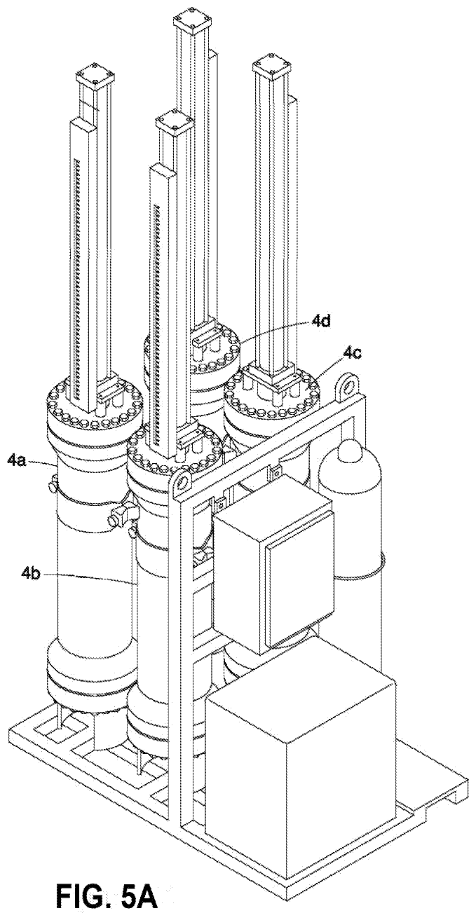

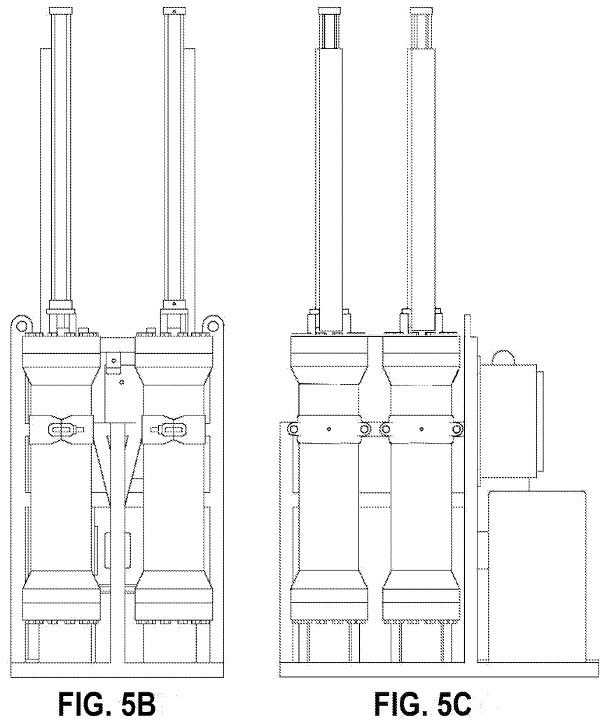

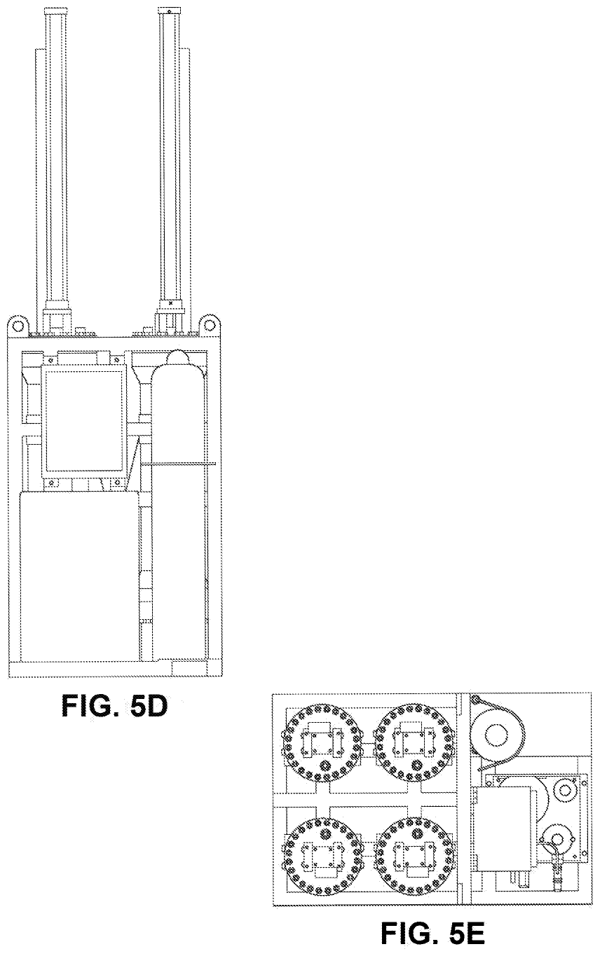

With references to the Figures, the present disclosure relates to a light liquid hydrocarbons sampling system 100 to sample light liquid hydrocarbons including NGLs, LPGs, condensates, as well as hazardous chemicals. The present sampling system novelly includes not one, but multiple accumulator vessels 2. FIGS. 2A to 4 represent an embodiment in which two accumulator vessels 4a and 4b are present. FIGS. 5A to 5E illustrate an embodiment in which four accumulator vessels 4a, 4b, 4c and 4d are present. The present sampling system allows for a separate batch of samples to be collected in each of the accumulators, while utilizing only one sampling pump 20 for collection of samples and delivering them to each of the accumulators.

In present system, while one accumulator vessel is being drained, samples can be collected over a next consecutive sample period in a subsequent accumulator, which is then ready for mixing and delivering a next representative sample. There is no need in the present system to wait for a single accumulator vessel to be emptied, then to be refilled over a sample period before a subsequent representative sample can be taken for testing. The system is preferably automated for switching to another accumulator, thus eliminating the requirement for a field operator to be physically present at batch end to empty the product collected for batch one, and start for batch two, three or four, and ensures an accurate representative sample for each batch of the liquids flowing in the pipeline.

In a further embodiment, the present sampling system uses only one sampling pump 20, connected in turn to all of the accumulator vessels 4a/4b/4c/4d. The sampling process and switching and selecting of accumulator vessel to send samples to is all automated to reduce manpower, which is beneficial in remote areas where manpower is not readily available and ensures no product contamination from previous batches.

The present sampling system communicates with one sample pump 20 mounted to a probe inserted into the flowing liquid of the pipeline. Product samples from the pump 20 is fed via product line 2 to the each of the accumulator vessels 4a/4b/4c/4d. Valves 6 on the product line 2 are actuatable to direct product flow to a particular accumulator vessel 4a/4b/4c/4d depending on the status of the other accumulator vessels being drained or not. In some cases, more than one accumulator vessel can receive product from the pump 20 at the same time. The present can preferably accommodate bi-directional flow, that is fluid flow travelling in either direction through the pipeline. Changes in flow direction in a pipeline can often occur between when that pipeline is being used, for example, to fill or feed a tank to when it is being used, for example, to empty or drain that tank. In a preferred embodiment, actuation of valve 6 is automatically controlled through the control system to be described in further detail below, and triggered through sensing of any one of the accumulator vessels being in a draining or non-use mode, after a sample period is completed.

The sampled product is maintained in a liquid phase within the accumulator vessels 4a/4b/4c/4d by means of pressure applied to the sampled product within the product accumulator vessel 4a/4b/4c/4d. In some cases, pressure can be applied by a piston 8 in each accumulator vessel 4a/4b that is actuated by pressurized gas from a pre-charge gas vessel 10. The pressurized gas enters the accumulator vessels 4a/4b/4c/4d at inlet 22 and applies pressure to a first side of the piston 8, thereby forcing the piston against the liquid on a second side of the piston 8 within the accumulator vessel 4a/4b/4c/4d preventing the hydrocarbon product from flashing, or losing it's light ends ie, methane, ethane, propane and butane. Valving 12 along the pressurized gas lines 12a controls distribution of pressurized gas to the appropriate accumulator vessels, the valving being more preferably tied into the control system to be described in more detail below to automate pressurizing of the accumulator vessels 4a/4b/4c/4d as needed. Preferably the pressurized gas is an inert gas to ensure that, in the chance of a leakage of pressurized gas around the piston 8 and into contact with the sample product, no reaction or contamination of the sample product would occur.

The present accumulator vessels 4a/4b/4c/4d each include internal mixers 24 to blend the collected samples in the vessels prior to a representative volume being taken, that can then be sampled and tested. The mixers 24 are preferably either pneumatically or hydraulically operable from either pressurized gas, air or hydraulic fluid 26. Timing and operation of the mixers 24 is controlled by the control system described below.

A source 28 of hydraulic fluid may be provided. Optionally either of the source of hydraulic fluid 28 or the pressurized gas from gas vessel 10 may actuate the sample pump 20.

While four accumulator vessels 4a/4b/4c/4d are discussed, it is equally possible to have more accumulator vessels connected to the product line 2 via pump 20, to provide additional and more frequent sampling and to scale up the sampling system based on product flow rates, volumes, and product types flowing through the pipeline. Additional accumulator vessels can also provide redundancy to the system should any accumulators vessels need replacement or repair.

All equipment, except the sample pumps, are mounted on a skid, or within a system enclosure.

The present accumulator vessel bodies are preferably made by spin cast machining, as a single piece with no welded parts. Unlike traditional vessels that have welded flanges for sealing, the present vessels have machined flanges with angled surfaces to reduce potential points of rusting and wear and to reduce weight. The present spun cast accumulator vessels can be machined to the same pressure rating and safety requirements as traditional vessels, but are found to be lighter in weight and can also be made smaller than traditional accumulator vessels on the market. The lighter, smaller build allows for more accumulator vessels to be included on a single skid of the present system 100 without adding proportional weight or footprint to the skid unit.

With reference to FIG. 5, the system further comprises a control system 14 in communication with data processing and display systems 16 that may be on site or remote.

Remote communication options for control include cellular, WiFi and Bluetooth so data records can be sent to or pulled from an application on a smart-phone, tablet or PC, reducing operator interface. The application may optionally include the ability to link with GIS (3D) back to an interactive Process & Instrumentation Diagram or a 3D model of the system.

The present control system 14 is compatible with most flow computers and can function as a stand-alone flow computer if needed. The control system 14 together with the data processing and display systems can be operator configurable to set up a notice when the desired capacity or sample time is reached in the accumulator tanks 4a/4b/4c/4d.

The control system 14 controls operation of the product line valves 6 to direct product from the sample pump 20 to particular accumulator vessels. The control system also receives readings from the various instrumentation to determine pressure in each accumulator vessel, sampling period time for each vessel, flow through each branch of the product line 2 to each accumulator vessel and other parameters. Pressure data from pressure inside each accumulator vessel is also provided to the control system to manipulate pressurized gas valves 12 to direct sufficient pressurized gas to each accumulator vessel during the sampling period.

The present control system 14 includes a PLC that can toggle between two receivers, A or B, adapting in real-time to the direction of the fluid stream in the pipeline, based on the signals from the flow computer. As such the present system accommodates bi-direcitonal flow of fluid travelling in either direction through the pipeline. The PLC is programmable to allow for receiver selection on a customizable schedule, be it weekly, daily, or any interval specified by the operator.

The system further comprises automated mixing capability, which can be pre-activated by the control system 14 prior to arrival of an operator, ensuring the sample's preparation is timely and that efficient sample taking can be performed. The automation is preferably driven by a 24 volt signal from the Flow Computer/Scada system, with the PLC being the hub of programmable operations.

To streamline operations and minimize the need for physical operator presence or oversight, the system integrates wireless technologies, including WiFi and Bluetooth™, facilitating the transmission of data directly to a smartphone, tablet, or PC allowing for remote check in and control. In scenarios requiring hydraulic actuation, the system is designed to connect to an external power source, in addition to the standard 24-volt signal.

The control system is configured to support additional accumulator vessels, including redundant accumulators. The dual-receiver and automated mixing capabilities minimizes a need operator intervention, optimizing sample collection rates and enhancing capacity to manage more sampling points within the same timeframe.

The previous description of the disclosed embodiments is provided to enable any person skilled in the art to make or use the present disclosure. Various modifications to those embodiments will be readily apparent to those skilled in the art, and the generic principles defined herein may be applied to other embodiments without departing from the spirit or scope of the disclosure. Thus, the present disclosure is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

What is claimed is:

1. A sampling system for sampling fluids flowing through a pipe, said system comprising;
a. at least two accumulator vessels;
b. a single sampling pump for collection of samples and delivering samples via sampling lines to one or more of the at least two accumulators;
c. one or more product valves associated with each of the accumulator vessels actuatable to direct sample flow to a particular accumulator vessel depending on the status of each of the at least two accumulator vessels; and
d. a control system in connection with the sampling pump, product valves and accumulator vessels for automation of the pumping of samples to a particular accumulator vessel, depending on status of each of the at least two accumulator vessels, to ensure consistent sample taking and accumulation;
wherein, the control system and sample pump is configured to accommodate bi-directional flow of fluid travelling through the pipe.

2. The sampling system of claim 1, wherein the control system is in communication with data processing and display systems that are on site or remote.

3. The sampling system of claim 2, wherein the control system 14 is compatible with a flow computer and is operator configurable to alarm when a desired accumulator vessel capacity or sample time is reached in any one or more of the at least two accumulator vessels.

4. The sampling system of claim 3, wherein the control system receives readings from instrumentation in the sampling system to determine pressure in each accumulator vessel, sampling period time for each accumulator vessel and flow through each branch of the sampling lines.

5. The sampling system of claim 4, wherein communication from the control system to remote data processing and display systems comprises cellular, WiFi and Bluetooth™.

6. The sampling system of claim 5, wherein the control system includes a PLC that can toggle between two receivers, A or B, adapting in real-time to the direction of the fluid flow in the pipe, based on the signals from the flow computer.

7. The sampling system of claim 6, wherein the PLC is programmable for receiver selection on a customizable schedule.

8. The sampling system of claim 1 further comprising a piston within each of the at least two accumulator vessels for applying pressure to the sampled product within the accumulator vessels.

9. The sampling system of claim 8, wherein the piston is actuated by pressurized gas that is distributed from a source of pressurized gas along gas lines, said gas lines including gas valves tied into the control system for controlling distribution of pressurized gas to particular accumulator vessels.

10. The sampling system of claim 9, wherein data from pressure inside each of the at least two accumulator vessels is processed by the control system to manipulate the pressurized gas valves to direct sufficient pressurized gas to each accumulator vessel during a sampling period.

11. The sampling system of claim 1, wherein each of the at least one accumulator vessels comprise an internal mixer to blend the collected samples in the accumulator vessels prior to a representative volume being taken.

12. The sampling system of claim 11, wherein the mixers are pneumatically driven from pressurized gas or hydraulically operable by a source of hydraulic fluid.

13. The sampling system of claim 12, wherein the mixers are automatable and programmable via the control system to initiate mixing at a predetermined time prior to arrival of an operator.

14. The sampling system of claim 1, wherein the at least two accumulator vessels comprise bodies that are made by spin cast machining, as a single piece with no welded parts.
